(19) United States
(12) Patent Application Publication
(10) Pub. No.: US 2002/0116858 A1
(43) Pub. Date: Aug. 29, 2002

(54) Hot tracks (game lures & cover scent)

(76) Inventors: Michael Valencic, Natrona Hts, PA (US); David Valencic, Natrona Hts, PA (US)

Correspondence Address: Michael Valencic, 212 Altermoor Drive, Natrona Hts, PA, 15065, US

(21) Appl. No.: 09/790,942

(22) Filed: Feb. 23, 2001

(51) Int. Cl. A01M 1/00

(52) U.S. Cl. 43/1

(57) ABSTRACT

The heat activated, scent impregnated or encapsulated game lure and cover scent provides a superior means to disperse and vaporize the scent molecules that attract animals and the cover scent helps to camouflage human odors for the purpose of hunting or trapping. A self-contained sealed strip, pad, wafer, or canister, once opened and exposed to air will cause heat. This in turn will cause the impregnated or encapsulated scent to be released without the use of messy liquids or gels. Heat will vaporize the scent, causing it to rise and travel on the air currents further and more efficiently.

### BACKGROUND OF THE INVENTION

Field of Endeavor

This invention relates to hunting and trapping game lures, cover scent, and more specifically to the self-contained, heat activated, scent impregnated or encapsulated lures used to attract animals for the purpose of hunting or trapping.

Current lures on the market include liquids, powders, gels, and solids. Although effective, they must be used carefully as not to spill any on themselves as the scent can be lasting and hard to wash off. These lures are typically applied to the ground, branches, or felt pads to disperse their scent. The problem with dispersing lures in this manner is that it creates a limited range of effectiveness. By applying the lure on the ground, an animal has to be very close to be attracted to it. Placing a game lure on branches or by hanging felt pads soaked with a game lure improves the effective range, but by using liquid or gels, care must be taken to avoid spilling the scent on themselves, creating an unsanitary condition. Other lures or devices on the market that rely on heat to help disperse their scent include the “Buck Hustler,” a lantern-like device that requires a propane bottle to fuel a flame to provide the necessary heat to vaporize the scent. There also are scented candles and concentrated scent sticks, but they too require an open flame which poses a fire hazard, especially on dry leaves, the time of year these products will be used. With the self-contained, heat activated, scent impregnated or encapsulated game lures, a more efficient means is provided to disperse the scent without the mess of the other products, and a product is provided without the fire hazards as those with an open flame.

### BRIEF SUMMARY OF THE INVENTION

The self-contained, heated, scent impregnated or encapsulated game lures and cover scent provides a practical and efficient means to attract game animals and the cover scent helps camouflage human odors for the purpose of hunting or trapping. By using a scent impregnated or encapsulated material, the user is provided a more efficient and sanitary way to apply the lure. When air activated a chemical compound produces heat providing a more efficient means to disperse the scent with a vaporizing action without the hazards of an open flame. Being self-contained, there is no mixing, soaking, or inconvenience involved. Simply open the package and the vaporizing action starts to disperse the scent without the mess or hazards of other products.

### BRIEF DESCRIPTION OF THE DRAWING

These features and advantages of the present invention will become apparent in the following specification. By no means is this information restrictive to the invention. Therefore, the information contained herein is only exemplary and explanatory.

FIG. 1 shows the Hot Tracks game lure and cover scent delivery system, excluding packaging, in its entirety.

### DETAILED DESCRIPTION OF THE INVENTION

Referring now more particularly to the drawing, and to the embodiments of the invention herein presented by way of illustration, the Hot Tracks game lure scent delivery system shown in

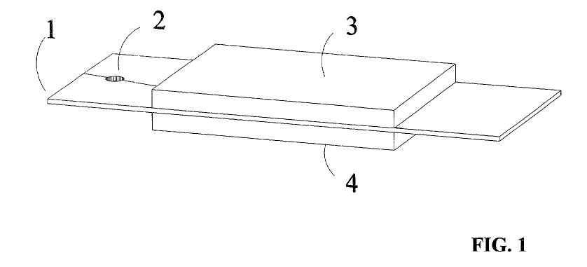

FIG. 1 of the drawing includes a contamination barrier designated at 1, a ¼ inch diameter hole 2, is punched at the top of the contamination barrier, centered ½ inches from top of the barrier. The hole 2, is used to hang the scent delivery system on a branch of a tree. A rope tied through the punched hole 2, will enable the scent delivery system to be dragged behind the person creating a scent trail leading to a desired location. The scent module 3, can be constructed by impregnating or encapsulating specific specie pheromones or cover scents into or onto any material that is highly absorbent. The scent module 3, is bonded to the contamination barrier 1. The heat module 4, is air activated, producing heat that is odorless and will not alarm the specie, being hunted, of danger. The heat produced from heating module 4, will cause the impregnated or encapsulated pheromones, or cover scent contained in scent module 3, to evaporate more readily thereby releasing the pheromones or cover scent into the atmosphere and carried by the prevailing winds. The heat module 4, is also bonded to the contamination barrier 1. The Hot Tracks game lure and cover scent delivery system shown in FIG. 1 must be vacuumed packed stopping the air from activating the heat module 4. Evaporation rates of the scent module 3, encapsulated pheromones will be determined by the manufacturer and can be applied directly on or into heat module 4, eliminating the contamination barrier 1. The dimensions of the Hot Tracks game lure and cover scent delivery system shown in FIG. 1, will be determined by the manufacturer. The volume of game lure and cover scent contained in scent module 3, is to be determined by the manufacturer. The Hot Tracks game lure and cover scent delivery system shown in FIG. 1 is biodegradable and will not harm the environment.

What we claim as our invention is:

1. A self-contained game lure or cover scent, comprising of a two-part system containing a scent impregnated or encapsulated material and a chemical compound when activated by air provides heat to vaporize and disperse the scent more efficiently.

2. The game lure or cover scent of claim 1, wherein the scent impregnated or encapsulated material can be any substance which is capable of absorbing and retaining the impregnated or encapsulated scent.

3. The game lure or cover scent of claim 1, wherein the scent impregnated or encapsulated material can be in the form of a strip, pads, canisters, etc.

4. The game lure or cover scent of claim 1, wherein the scent impregnated or encapsulated material is separated from the chemical compound by means of a physical barrier, the physical barrier being such that allows heat to be transferred to the game lure.

5. The game lure or cover scent of claim 1, wherein the chemical compound is activated when exposed to air producing heat.

6. The game lure or cover scent of claim 1, wherein the chemical compound does not pose a fire hazard when activated.

7. The game lure of claim 1, wherein the self-contained, scent impregnated or an encapsulated lure provides a sanitary solution for the purpose of dispersing scent to attract animals.

8. The cover scent of claim 1, helps to camouflage a human odors.

9. The game lure or cover scent of claim 1, wherein the heated scent impregnated or encapsulated material provides a more efficient and practical means to disperse the scent.
